(19) United States
(12) Patent Application Publication
(10) Pub. No.: US 2023/0155249 A1
(43) Pub. Date: May 18, 2023

(54) BATTERY INCLUDING ION BARRIER LAYER AND ELECTRONIC DEVICE INCLUDING THE SAME

(71) Applicant: SAMSUNG ELECTRONICS CO., LTD., Suwon-si (KR)

(72) Inventors: Yeonil LEE, Suwon-si (KR); Jonggyu PARK, Suwon-si (KR); Sinyoung JUNG, Suwon-si (KR)

(73) Assignee: SAMSUNG ELECTRONICS CO., LTD., Suwon-si (KR)

(21) Appl. No.: 17/980,361

(22) Filed: Nov. 3, 2022

Related U.S. Application Data
(63) Continuation of application No. PCT/KR2022/013382, filed on Sep. 6, 2022.

(30) Foreign Application Priority Data
Nov. 17, 2021 (KR) 10-2021-0158895

(51) Int. Cl. H01M 50/451; H01M 10/0587; H01M 4/36; H01M 10/0525

(52) U.S. Cl. CPC H01M 50/451; H01M 10/0587; H01M 4/364; H01M 10/0525; H01M 2004/027

(57) ABSTRACT

A battery includes: a negative electrode including a negative electrode substrate layer and a negative electrode active material-coated negative electrode mixture layer on the negative electrode substrate layer; a positive electrode facing the negative electrode, the positive electrode including: a positive electrode substrate layer; a positive electrode active material-coated positive electrode mixture layer provided on the positive electrode substrate layer; and a barrier layer configured to suppress transfer of ions from the positive electrode active material-coated positive electrode mixture layer; and a separator provided between the negative electrode and the positive electrode, wherein the positive electrode active material-coated positive electrode mixture layer includes a first area at a center area of the positive electrode active material-coated positive electrode mixture layer and a second area at an edge of the positive electrode active material-coated positive electrode mixture layer, and wherein the barrier layer covers at least a portion of the second area and is further configured to limit direct transfer of the ions from the first area to the negative electrode.

### CROSS-REFERENCE TO RELATED APPLICATIONS

This application is a bypass continuation of International Patent Application No. PCT/KR2022/013382, filed on Sep. 6, 2022, which claims priority to Korean Patent Application No. 10-2021-0158895, filed on Nov. 17, 2021, in the Korean Intellectual Property Office, the disclosures of which are incorporated by reference herein their entireties.

### BACKGROUND

### 1. Field

The disclosure relates to a battery including an ion barrier layer, and/or an electronic device including the same.

### 2. Description of Related Art

Advancing information communication technology and semiconductor technology accelerate the spread and use of various electronic devices. In particular, recent electronic devices are being developed to carry out communication while being carried on a user. Further, electronic devices may output stored information as voices or images. As electronic devices are highly integrated, and high-speed, high-volume wireless communication becomes commonplace, an electronic device, such as a mobile communication terminal, is recently being equipped with various functions. For example, an electronic device comes with the integrated functionality, including an entertainment function, such as playing video games, a multimedia function, such as replaying music/videos, a communication and security function for mobile banking, and a scheduling and e-wallet function. Such electronic devices become compact enough for users to carry in a convenient way. As electronic devices are put to everyday use, users' demand for portability and usability of electronic devices may increase. According to such user demand, secondary batteries which are chargeable and dischargeable, as a power source for electronic devices, are used.

A lithium ion battery used as a secondary battery includes a combination of electrode assemblies each including a positive electrode, a negative electrode, and a separator. The positive electrode and the negative electrode may include an electrode substrate and a mixture coated on the electrode substrate and containing an active material. The lithium-ion battery may convert chemical energy into electrical energy by redox reactions at the positive and negative electrodes and may transfer the electrical energy through a positive electrode tap connected to the positive electrode and a negative electrode tap connected to the negative electrode. The capacity of the battery is basically proportional to the size of the area where the positive electrode and the negative electrode face each other. Therefore, in light of design or process, it may be most efficient to make the positive electrode and the negative electrode in the same size. However, in this structure, Li ions from the edge of the positive electrode (including the side of the coating) may accumulate on the edge of the negative electrode, deteriorating the reliability and safety of the battery (a Li dendrite buildup). Therefore, the related art requires that the negative electrode are manufactured to have a greater size, rendering it difficult to maximize battery capacity and causing many design limitations.

### SUMMARY

According to one or more embodiments of the disclosure, a battery may have an increased area of positive active material layer for storing positive ions and may have capacity increased by suppressing ion dendrites generated at the negative electrode.

The disclosure is not limited to the foregoing embodiments and various modifications or changes may be made thereto without departing from the spirit and scope of the disclosure.

### Technical Solution

According to an aspect of the disclosure, a battery includes: a negative electrode including a negative electrode substrate layer and a negative electrode active material-coated negative electrode mixture layer on the negative electrode substrate layer; a positive electrode facing the negative electrode, the positive electrode including: a positive electrode substrate layer; a positive electrode active material-coated positive electrode mixture layer provided on the positive electrode substrate layer; and a barrier layer configured to suppress transfer of ions from the positive electrode active material-coated positive electrode mixture layer; and a separator provided between the negative electrode and the positive electrode, wherein the positive electrode active material-coated positive electrode mixture layer includes a first area at a center area of the positive electrode active material-coated positive electrode mixture layer and a second area at an edge of the positive electrode active material-coated positive electrode mixture layer, and wherein the barrier layer covers at least a portion of the second area and is further configured to limit direct transfer of the ions from the first area to the negative electrode.

The second area may include at least a portion from an upper edge area of the positive electrode active material-coated positive electrode mixture layer to a side surface of the positive electrode active material-coated positive electrode mixture layer extending from the upper edge area.

A thickness of the second area may be smaller than a thickness of the first area.

The second area may be formed by etching at least a portion of an upper edge of the positive electrode active material-coated positive electrode mixture layer or may be thinner than the center area of the positive electrode active material-coated positive electrode mixture layer.

A length of the second area may be 5% to 10% of a length of the first area.

The barrier layer may be provided on at least a portion of the positive electrode substrate layer.

The battery may further include an insulation layer configured to suppress movement of electrons, and the insulation layer may be provided inside or outside at least a portion of the barrier layer.

The insulation layer may cover at least a portion of the positive electrode substrate layer.

The barrier layer may include at least one material among a metal nitride or a polymer material.

The barrier layer may be deposited by any one of chemical layer deposition, physical vapor deposition, or atomic layer deposition.

A width of the negative electrode active material-coated negative electrode mixture layer may correspond to a width of the positive electrode active material-coated positive electrode mixture layer.

The battery may be a jelly-roll type battery or a stack type battery.

According to an aspect of the disclosure, a battery includes: a negative electrode including a negative electrode substrate layer and a negative electrode active material-coated negative electrode mixture layer on the negative electrode substrate layer; a positive electrode facing the negative electrode, the positive electrode including: a positive electrode substrate layer, a positive electrode active material-coated positive electrode mixture layer provided on the positive electrode substrate layer; and a barrier layer configured to suppress transfer of ions from the positive electrode active material-coated positive electrode mixture layer; and a separator provided between the negative electrode and the positive electrode, wherein the positive electrode active material-coated positive electrode mixture layer includes: a main area configured to store cations and including a transfer area configured to transfer the cations to the negative electrode; and an additional area extending from the main area and configured to store the cations, and wherein the barrier layer covers the additional area and is configured to suppress the cations stored in the additional area from being directly transferred to the negative electrode.

The additional area may include a barrier receiving area having a thickness that is smaller than a thickness of the main area, and the barrier layer may be provided in the barrier receiving area.

The barrier layer may cover at least a portion of the positive electrode substrate layer.

The battery may further include an insulation layer configured to suppress movement of electrons, and the insulation layer may be provided inside or outside at least a portion of the barrier layer.

The insulation layer may be provided on at least a portion of the positive electrode substrate layer.

The barrier layer may include a metal nitride or a polymer material.

The barrier layer may be deposited by any one of chemical layer deposition, physical vapor deposition, or atomic layer deposition.

According to an aspect of the disclosure, an electronic device includes: a processor; and a battery configured to supply power to the processor; wherein the battery includes: a negative electrode including a negative electrode substrate layer and a negative electrode active material-coated negative electrode mixture layer on the negative electrode substrate layer; a positive electrode facing the negative electrode, the positive electrode including: a positive electrode substrate layer; a positive electrode active material-coated positive electrode mixture layer provided on the positive electrode substrate layer; and a barrier layer configured to suppress transfer of ions from the positive electrode active material-coated positive electrode mixture layer; and a separator provided between the negative electrode and the positive electrode, wherein the positive electrode active material-coated positive electrode mixture layer includes a first area at a center area of the positive electrode active material-coated positive electrode mixture layer and a second area at an edge of the positive electrode active material-coated positive electrode mixture layer, and wherein the barrier layer covers at least a portion of the second area and is further configured to limit direct transfer of the ions from the first area to the negative electrode.

### Advantageous Effects

Provided is a battery including an ion barrier layer disposed on a positive electrode mixture to control the transfer path of positive ions to a negative electrode. Therefore, a battery may have a capacity of a positive electrode active material increased and side effects, e.g., ion dendrites, reduced or prevented.

### BRIEF DESCRIPTION OF THE DRAWINGS

The above and/or other aspects, features, and advantages of certain embodiments will be more apparent from the following description taken in conjunction with the accompanying drawings, in which:

FIG. 1 is a block diagram illustrating an electronic device in a network environment according to various embodiments;

FIG. 2 is a front perspective view illustrating an electronic device according to various embodiments;

FIG. 3 is a rear perspective view illustrating an electronic device according to various embodiments;

FIG. 4 is an exploded perspective view illustrating an electronic device according to various embodiments;

FIG. 5 is a view illustrating an implementation example of a battery according to various embodiments;

FIG. 6 is a perspective view illustrating an electrode configuration of a battery according to various embodiments;

FIG. 7 is a front view illustrating a battery according to various embodiments;

FIG. 8 is a top view illustrating a battery according to various embodiments;

FIG. 9 is a view schematically illustrating an electrode assembly according to various embodiments;

FIG. 10 is a view illustrating an ion barrier structure according to various embodiments;

FIG. 11 is a view illustrating an ion movement in an ion barrier structure according to various embodiments;

FIG. 12 is a view illustrating an ion barrier structure including an insulation layer according to various embodiments;

FIG. 13 is a view illustrating a process for manufacturing an ion barrier structure according to a first embodiment;

FIG. 14 is a view illustrating a process for manufacturing an ion barrier structure according to a second embodiment;

FIG. 15 is a view illustrating a process for manufacturing an ion barrier structure according to a third embodiment; and

FIG. 16 is a view illustrating a process for manufacturing an ion barrier structure according to a fourth embodiment.

### DETAILED DESCRIPTION

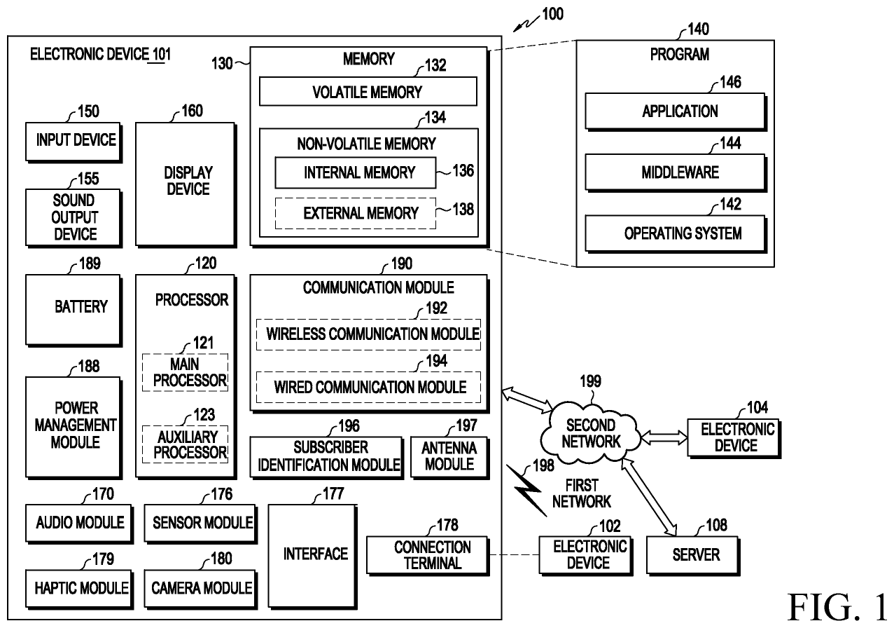

FIG. 1 is a block diagram illustrating an electronic device in a network environment according to various embodiments;

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160). The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module may include an antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

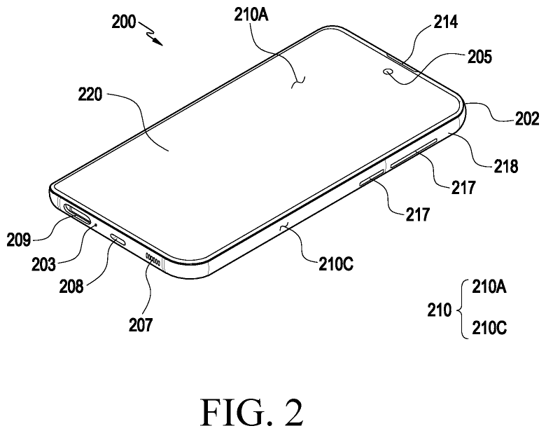

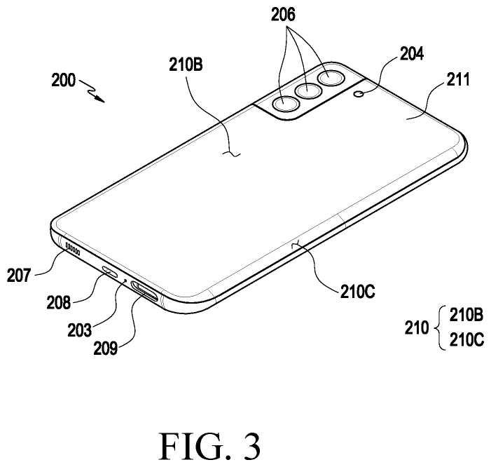

FIG. 2 is a front perspective view illustrating an electronic device according to various embodiments. FIG. 3 is a rear perspective view illustrating an electronic device according to various embodiments.

Referring to FIGS. 2 and 3, according to an embodiment, an electronic device 200 may include a housing 210 with a front surface 210A, a rear surface 210B, and a side surface 210C surrounding a space between the front surface 210A and the rear surface 210B. According to another embodiment, the housing 210 may denote a structure forming part of the front surface 210A, the rear surface 210B, and the side surface 210C of FIG. 2. According to an embodiment, at least part of the front surface 210A may have a substantially transparent front plate 202 (e.g., a glass plate or polymer plate including various coat layers). The rear surface 210B may be formed by a rear plate 211. The rear plate 211 may be formed of, e.g., glass, ceramic, polymer, metal (e.g., aluminum, stainless steel (STS), or magnesium), or a combination of at least two thereof. The side surface 210C may be formed by a side bezel structure (or a “side member”) 218 that couples to the front plate 202 and the rear plate 211 and includes a metal and/or polymer. According to an embodiment, the rear plate 211 and the side bezel plate 218 may be integrally formed together and include the same material (e.g., glass, metal, such as aluminum, or ceramic). According to another embodiment, the front surface 210A and/or the front plate 202 may include a part of the display 220.

According to an embodiment, the electronic device 200 may include at least one of a display 220, audio modules 203, 207, and 214 (e.g., the audio module 170 of FIG. 1), a sensor module (e.g., the sensor module of FIG. 1). 176), camera modules 205 and 206 (e.g., the camera module 180 of FIG. 1), a key input device 217 (e.g., the input module 150 of FIG. 1), and connector holes 208 and 209 (e.g., the connection terminal 178 of FIG. 1). According to an embodiment, the electronic device 200 may exclude at least one (e.g., the connector hole 209) of the components or may add other components. According to an embodiment, the display 220 may be visually revealed through, e.g., a majority portion of the front plate 202.

According to an embodiment, the surface (or the front plate 202) of the housing 210 may include a screen display area formed as the display 220 being visually exposed. For example, the screen display area may include the front surface 210A.

According to another embodiment, the electronic device 200 may include a recess or opening formed in a portion of the screen display area (e.g., the front surface 210A) of the display 220 and may include at least one or more of an audio module 214, a sensor module, a light emitting device, and a camera module 205 aligned with the recess or opening. According to another embodiment, at least one or more of the audio module 214, sensor module, camera module 205, fingerprint sensor, and light emitting device may be included on the rear surface of the screen display area of the display 220.

According to an embodiment, the display 220 may be disposed to be coupled with, or adjacent, a touch detecting circuit, a pressure sensor capable of measuring the strength (pressure) of touches, and/or a digitizer for detecting a magnetic field-type stylus pen.

In some embodiments, at least a portion of the key input device 217 may be disposed on the side bezel structure 218.

According to an embodiment, the audio modules 203, 207, and 214 may include, e.g., a microphone hole 203 and speaker holes 207 and 214. The microphone hole 203 may have a microphone inside to obtain external sounds. According to an embodiment, there may be a plurality of microphones to be able to detect the direction of a sound. The speaker holes 207 and 214 may include an external speaker hole 207 and a phone receiver hole 214. According to an embodiment, the speaker holes 207 and 214 and the microphone hole 203 may be implemented as a single hole, or speakers may be included without the speaker holes 207 and 214 (e.g., piezo speakers).

According to an embodiment, the sensor modules may generate an electrical signal or data value corresponding to an internal operating state or external environmental state of the electronic device 200. The sensor module may include, e.g., a first sensor module (e.g., a proximity sensor) and/or a second sensor module (e.g., a fingerprint sensor) disposed on the front surface 210A of the housing 210. The sensor module may include a third sensor module (e.g., an HRM sensor) and/or a fourth sensor module (e.g., a fingerprint sensor) disposed on the rear surface 210B of the housing 210). In an embodiment, the fingerprint sensor may be disposed on the rear surface 210B as well as on the front surface 210A (e.g., the display 220) of the housing 210. The electronic device 200 may further include sensor modules, e.g., at least one of a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor.

According to an embodiment, the camera modules 205 and 206 may include a front camera module 205 disposed on the first surface 210A of the electronic device 200 and a rear camera module 206 and/or a flash 204 disposed on the rear surface 210B. The camera modules 205 and 206 may include one or more lenses, an image sensor, and/or an image signal processor. The flash 204 may include, e.g., a light emitting diode (LED) or a xenon lamp. According to an embodiment, two or more lenses (an infrared (IR) camera, a wide-angle lens, and a telephoto lens) and image sensors may be disposed on one surface of the electronic device 200.

According to an embodiment, the key input device 217 may be disposed on the side surface 210C of the housing 210. According to an embodiment, the electronic device 200 may exclude all or some of the above-mentioned key input devices 217 and the excluded key input devices 217 may be implemented in other forms, e.g., as soft keys, on the display 220.

According to an embodiment, the light emitting device may be disposed on, e.g., the front surface 210A of the housing 210. The light emitting device may provide, e.g., information about the state of the electronic device 200 in the form of light. According to another embodiment, the light emitting device may provide a light source that interacts with, e.g., the front camera module 205. The light emitting device may include, e.g., a light emitting diode (LED), an infrared (IR) LED, and/or a xenon lamp.

According to an embodiment, the connector holes 208 and 209 may include a first connector hole 208 configured to receive a connector (e.g., an earphone jack) configured to transmit/receive audio signals to/from an external electronic device or a connector (e.g., a USB connector) configured to transmit/receive power and/or data to/from the external electronic device and/or a second connector hole 209 for receiving a storage device (e.g., a subscriber identification module (SIM) card). According to an embodiment, the first connector hole 208 and/or the second connector hole 209 may be omitted.

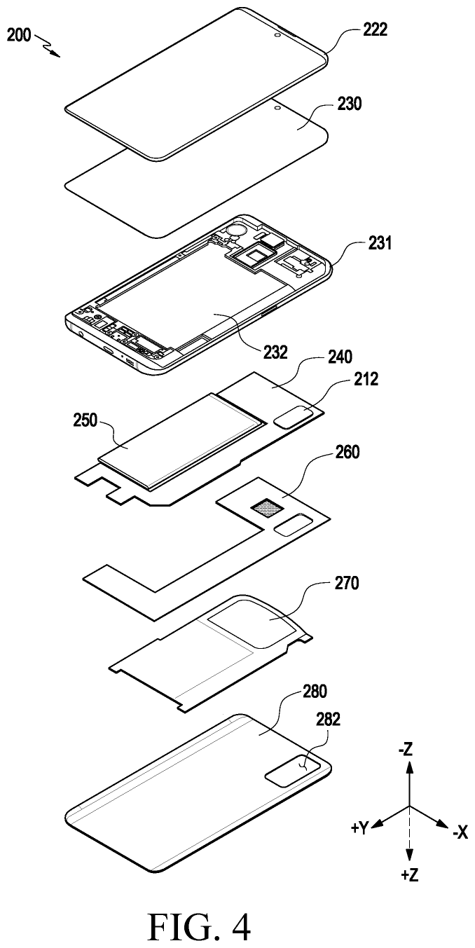

FIG. 4 is an exploded perspective view illustrating an electronic device according to various embodiments.

Referring to FIG. 4, an electronic device 200 (e.g., the electronic device 200 of FIGS. 2 and 3) may include at least one of a front plate 220 (e.g., the front plate 202), a display 230 (e.g., the display 201 of FIG. 2), a first supporting member 232 (e.g., a bracket), a printed circuit board 240, a battery 250, a second supporting member 260 (e.g., a rear case), an antenna 270, and a rear plate 280 (e.g., the rear plate 211 of FIG. 3). According to an embodiment, the electronic device 200 may exclude at least one (e.g., the first supporting member 232 or the second supporting member 260) of the components or may add other components. At least one of the components of the electronic device 200 may be the same or similar to at least one of the components of the electronic device 200 of FIG. 2 or 3 and no duplicate description is made below.

According to an embodiment, the first supporting member 232 may be disposed inside the electronic device 200 to be connected with the side bezel structure 231 or integrated with the side bezel structure 231. The first supporting member 232 may be formed of, e.g., a metallic material and/or non-metallic material (e.g., polymer). The display 230 may be disposed on and joined (connected) onto one surface of the first supporting member 232, and the printed circuit board 240 may be disposed on and joined (connected) onto the opposite surface of the first supporting member 311. A processor, memory, and/or interface may be mounted on the printed circuit board 240. The processor may include one or more of, e.g., a central processing unit, an application processor, a graphic processing device, an image signal processing, a sensor hub processor, or a communication processor. According to an embodiment, the memory may include, e.g., a volatile or non-volatile memory. According to an embodiment, the interface may include, e.g., a high definition multimedia interface (HDMI), a universal serial bus (USB) interface, a secure digital (SD) card interface, and/or an audio interface. The interface may electrically or physically connect, e.g., the electronic device 200 with an external electronic device and may include a USB connector, an SD card/multimedia card (MMC) connector, or an audio connector. According to an embodiment, the battery 250 (e.g., the battery 189 of FIG. 1) may be a device for supplying power to at least one component (e.g., the camera module 212) of the electronic device 200. The battery 189 may include, e.g., a primary cell which is not rechargeable, a secondary cell which is rechargeable, or a fuel cell. At least a portion of the battery 250 may be disposed on substantially the same plane as the printed circuit board 240. The battery 250 may be integrally or detachably disposed inside the electronic device 200.

According to various embodiments, the second supporting member 260 (e.g., a rear case) may be disposed between the printed circuit board 240 and the antenna 270. For example, the second supporting member 260 may include one surface to which at least one of the printed circuit board 240 and the battery 250 is disposed on and coupled (connected), and another surface to which the antenna 270 is disposed on and coupled (connected).

According to an embodiment, the antenna 270 may be disposed between the rear plate 280 and the battery 250. The antenna 270 may include, e.g., a near-field communication (NFC) antenna, a wireless charging antenna, and/or a magnetic secure transmission (MST) antenna. The antenna 270 may perform short-range communication with, e.g., an external device or may wirelessly transmit or receive power necessary for charging. For example, the antenna 270 may include a coil for wireless charging. According to an embodiment, an antenna structure may be formed by a portion or combination of the side bezel structure 231 and/or the first supporting member 232.

According to various embodiments, the electronic device 200 may include a camera module (e.g., the camera module 206 of FIG. 3) disposed in the housing (e.g., the housing 210 of FIG. 2). According to an embodiment, the camera module 206 may be disposed on the first supporting member 232 and may be a rear camera module (e.g., the camera module 212 of FIG. 3) configured to obtain an image of a subject positioned behind (e.g., the +Z direction) of the electronic device 200. According to an embodiment, at least a portion of the camera module 212 may be exposed to the outside of the electronic device 200 through the opening 282 formed in the rear plate 280.

The electronic device 200 disclosed in FIGS. 2 to 4 has a bar-type or plate-type appearance, but embodiments are not limited thereto. For example, the illustrated electronic device may be a rollable electronic device or a foldable electronic device. A rollable electronic device may be an electronic device at least a portion of which may be wound or rolled or received in a housing (e.g., the housing 210 of FIG. 2) as the display (e.g., the display 230 of FIG. 4) may be bent and deformed. As the display is stretched out or is exposed to the outside in a larger area according to the user's need, the rollable electronic device may use an expanded second display area. A foldable electronic device may be an electronic device that may be folded in directions to face two different areas of the display or in directions opposite to each other. In general, in the portable state, the foldable electronic device may be folded so that the two different areas of the display face each other and, in an actual use state, the user may unfold the display so that the two different areas form a substantially flat shape. According to various embodiments, the electronic device 200 may include various electronic devices, such as a laptop computer or a camera, as well as a portable electronic device, such as a smart phone.

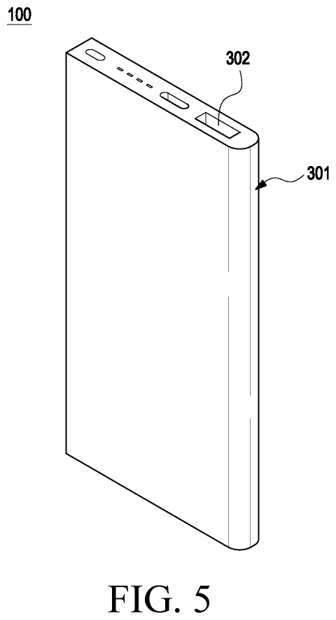

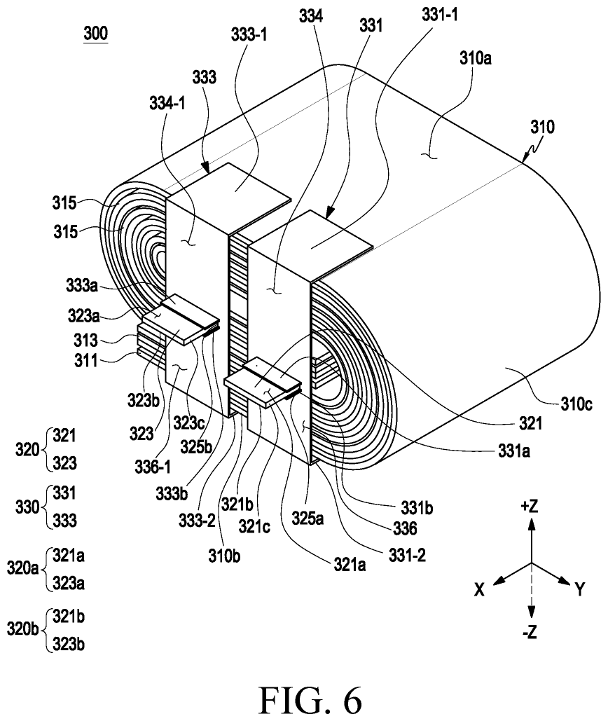

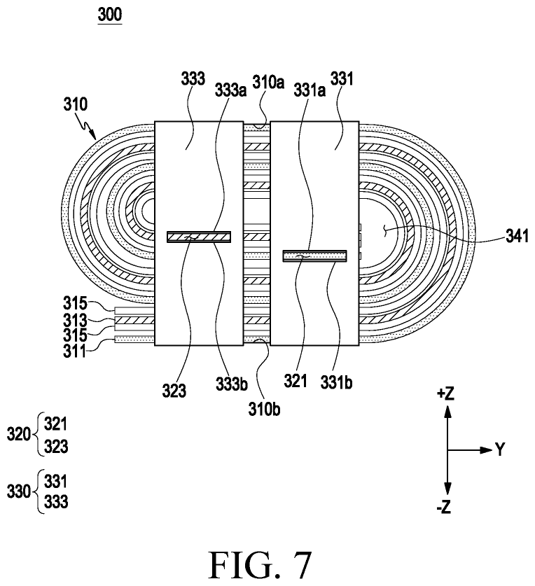

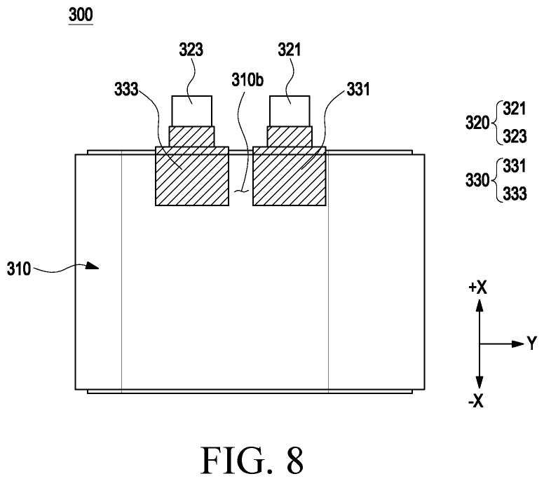

FIG. 5 is a view illustrating an implementation example of a battery according to various embodiments. FIG. 6 is a perspective view illustrating an electrode configuration of a battery according to various embodiments. FIG. 7 is a front view illustrating a battery according to various embodiments. FIG. 8 is a top view illustrating a battery according to various embodiments.

Referring to FIGS. 5 to 8, a battery 300 may include a case 301 and an electrode assembly 310 disposed in the case 301.

According to various embodiments, the battery 300 may supply power to at least one component of various electronic devices (e.g., the electronic device 101 of FIG. 1). For example, the electronic device may include a mobile device (e.g., a smart phone), a wearable device, a laptop computer, and/or a portable wireless charger. Moreover, the battery 300 may be mounted in various electronic devices requiring power supply. According to an embodiment, the battery 300 may be a rechargeable secondary battery. According to an embodiment, the battery 300 may be a jelly roll battery that may be disposed in an electronic device (e.g., a mobile phone).

According to various embodiments, the case 301 may form the exterior of the battery 300 and may provide a space configured to receive the electrode assembly 310. According to an embodiment, the case 301 may include a pouch or a can structure encapsulating the electrode assembly 310. According to an embodiment, the case 301 may be bendable. For example, the case 301 may be formed of a flexible material. According to an embodiment, the case 301 may include at least one terminal 302 to be electrically connected to an external electronic device.

According to various embodiments, the battery 300 may include an electrode assembly 310, an electrode tab 320, and/or a protection member 330.

According to various embodiments, the electrode assembly 310 may include a positive electrode 311, a negative electrode 313, and a separator 315. For example, the electrode assembly 310 may be at least one unit cell that includes the positive electrode 311, the negative electrode 313, and at least one separator 315 for preventing contact between the positive electrode 311 and the negative electrode 313. According to an embodiment, the electrode assembly 310 may be disposed in the case 301.

According to an embodiment, the electrode assembly 310 may be formed in a wound roll shape. For example, the electrode assembly 310 may be a jelly roll battery. According to an embodiment, the electrode assembly 310 may include a first surface 310a facing in a first direction (e.g., +Z direction) and a second surface 310b facing in a second direction (e.g., −Z direction). For example, the electrode assembly 310 may include the first surface 310a, the second surface 310b, and a third surface 310c extending from the first surface 310a to the second surface 310b. The second surface 310b may be opposite to the first surface 310a. According to an embodiment, the first surface 310a, the second surface 310b, and the third surface 310c may be formed by one of the positive electrode 311, the negative electrode 313, or the separator 315.

According to an embodiment, the electrode assembly 310 may be a stack type battery. For example, the electrode assembly 310 may include a plurality of positive electrodes 311, a plurality of negative electrodes 313, and a plurality of separators 315 that are alternately stacked.

According to various embodiments, the electrode tab 320 may be connected to the electrode assembly 310. For example, the electrode tab 320 may be connected to the positive electrode 311 or the negative electrode 313 of the electrode assembly 310. According to an embodiment, the electrode tab 320 may include a path for transferring the electric power stored in the electrode assembly 310 to the outside of the electrode assembly 310. According to an embodiment, at least a portion of the electrode tab 320 may protrude to the outside of the electrode assembly 310, supplying power to a component of the electronic device (e.g., the electronic device 200 of FIG. 2).
According to various embodiments, the electrode tab 320 may include a positive electrode tab 321 electrically connected to the positive electrode 311 and a negative electrode tab 323 electrically connected to the negative electrode 313. According to an embodiment, the positive electrode tab 321 may be connected to a positive electrode substrate (e.g., the positive electrode substrate 311a of FIG. 7) of the positive electrode 311, and the negative electrode tab 323 may be connected to a negative electrode substrate (e.g., the negative electrode substrate 313a of FIG. 7) of the negative electrode 313.
According to another embodiment, the positive electrode tab 321 may be connected to the positive electrode substrate 311a at a plurality of points, and the negative electrode tab 323 may be connected to the negative electrode substrate 313a at a plurality of points.

According to various embodiments, the electrode tab 320 may include protrusion areas 325a and 325b exposed to the outside of the electrode assembly 310. According to an embodiment, the protrusion areas 325a and 325b may include a junction area where the electrode tab 320 is welded to the electrode assembly 310. For example, the positive electrode tab 321 may be connected to the positive electrode 311 by the positive electrode protrusion area 325a, and the negative electrode tab 323 may be connected to the negative electrode 313 by the negative electrode protrusion area 325b. For example, the positive electrode protrusion area 325a may be a portion of the positive electrode tab 321 extending from a junction electrically connected to the positive electrode 311 in the electrode assembly 310, and the negative electrode protrusion area 325b may be a portion of the negative electrode tab 323 extending from a junction electrically connected to the negative electrode 313 in the electrode assembly 310. According to an embodiment, the electrode tab 320 may be positioned substantially at the center of the electrode assembly 310.

According to various embodiments, the electrode tab 320 may include electrode tab surfaces 321a, 321b, 323a, and 323b that are substantially parallel to the first surface 310a or the second surface 310b of the electrode assembly 310. For example, the electrode tab 320 has an upper surface 320a (e.g., a first positive electrode tab surface 321a and a first negative electrode tab surface 323a) facing in the same direction (e.g., a first direction (+Z direction)) as the first surface 310a and a lower surface 320b (e.g., a second positive electrode tab surface 321b and a second electrode tab surface 323b) facing in the same (e.g., a second direction (−Z direction)) as the second surface 310b. According to an embodiment, the positive electrode tab 321 may include the first positive electrode tab surface 321a, the second positive electrode tab surface 321b opposite to the first positive electrode tab surface 321a, and a third positive electrode tab surface 321c surrounding and disposed adjacent to at least a portion between the first positive electrode tab surface 321a and the second positive electrode tab surface 321b. The negative electrode tab 323 may include the first negative electrode tab surface 323a, the second negative electrode tab surface 323b opposite to the first negative electrode tab surface 323a, and a third negative electrode tab surface 323c surrounding and disposed adjacent to at least a portion between the first negative electrode tab surface 323a and the second negative electrode tab surface 323b.

According to various embodiments, the protection member 330 may reduce or prevent a short circuit of the battery 300. For example, the protection member 330 may reduce or prevent the contact between the positive electrode tab 321 and the negative electrode 313 and/or the contact between the negative electrode tab 323 and the positive electrode 311. According to an embodiment, at least a portion of the protection member 330 may be disposed on the protrusion areas 325a and 325b of the electrode tab 320. For example, the protection member 330 may be attached so that the electrode tab 320 is provided adjacent to and surrounds the protruding portion of the electrode assembly 310.

According to various embodiments, the protection member 330 may reduce or prevent deformation of the electrode assembly 310. According to an embodiment, the protection member 330 may reduce expansion of the electrode assembly 310 when swelling occurs in the electrode assembly 310. For example, according to an embodiment, the protection member 330 may be attached to be disposed adjacent to and surround at least a portion of the outer surface of the electrode assembly 310. The protection member 330 may extend from the first surface 310a through the protrusion areas 325a and 325b to the second surface 310b, reducing shape deformation of the electrode assembly 310. According to an embodiment, the protection member 330 may be disposed on and cover a portion of the positive electrode 311, the negative electrode 313, and the separator 315. According to an embodiment, the protection member 330 may include anti-deformation tape. According to an embodiment, the protection member 330 may include polyethylene terephthalate (PET) or polyimide. For example, the protection member 330 may be a protection tape. As another example, the protection member 330 may be formed of a liquid, solid, or semi-solid material.

According to various embodiments, the protection member 330 may be disposed on the positive electrode tab 321 and the negative electrode tab 323. According to an embodiment, the protection member 330 may include a first protection member 331 surrounding and disposed adjacent to at least a portion of the positive electrode tab 321 and a second protection member 333 surrounding and disposed adjacent to at least a portion of the negative electrode tab 323. According to an embodiment, the first protection member 331 may include a first portion 331-1 attached on the first surface 310a and a second portion 331-2 attached on the second surface 310b. According to an embodiment, the first protection member 331 may include a first cover area 331a disposed on the first positive electrode tab surface 321a and a second cover area 331b disposed on the second positive electrode tab surface 321b. According to an embodiment, the second protection member 333 may include a third portion 333-1 attached on the first surface 310a and a fourth portion 333-2 attached on the second surface 310b. According to an embodiment, the second protection member 333 may include a third cover area 333a disposed on the first negative electrode tab surface 323a and a fourth cover area 333b disposed on the second negative electrode tab surface 323b. According to an embodiment, the side surfaces (e.g., the third positive electrode tab surface 321c and the third negative electrode tab surface 323c) of the electrode tab 320 are not covered by the protection member 330 but may be exposed to the outside of the electrode assembly 310.

According to various embodiments, at least a portion of the protection member 330 may extend from the electrode assembly surfaces 310a and 310b to the electrode tab surfaces 321a, 321b, 323a, and 323b through the protrusion areas 325a and 325b. According to an embodiment, the first area 334 of the protection member 330 may extend from the first surface 310a to the upper surface 320a through the protrusion areas 325a and 325b, and the second area 336 of the protection member 330 may extend from the second surface 310b to the lower surface 320b through the protrusion areas 325a and 325b. For example, the first area 334 of the first protection member 331 may extend from the first surface 310a through the positive electrode protrusion area 325a to the first positive electrode tab surface 321a, and the second area 336 of the first protection member 331 may extend from the second surface 310b through the positive electrode protrusion area 325a to the second positive electrode tab surface 321b. A portion of the second protection member 333 may extend from the first surface 310a through the negative electrode protrusion area 325b to the first negative electrode tab surface 323a, and another portion of the second protection member 333 may extend from the second surface 310b to the second negative electrode tab surface 323b through the negative electrode protrusion area 325b. According to an embodiment, the protection member 330 may extend from the first surface 310a through the positive electrode 311, the negative electrode 313, and the separator 315 to the second surface 310b of the electrode assembly 310. According to an embodiment, one electrode tab (e.g., positive electrode tab 321 or negative electrode tab 323) may pass through a portion (e.g., first protection member 331 or second protection member 333) of one protection member 330. For example, the positive electrode tab 321 may pass through the first protection member 331, and the negative electrode tab 323 may pass through the second protection member 333. According to an embodiment, a plurality of (e.g., two) electrode tabs 320 (e.g., positive electrode tab 321 and negative electrode tab 323) may pass through a portion of one protection member 330. According to an embodiment, each of the first protection member 331 and the second protection member 333 may be a tape. According to an embodiment, the first protection member 331 and/or the second protection member 333 may include a plurality of tapes. For example, the first area 334, the second area 336, the first cover area 331a, and the second cover area 331b of the first protection member 331 each may be separate tapes, and the first area 334-1, the second area 336-1, the third cover area 333a, and the fourth cover area 333b of the second protection member 333 each may be separate tapes.

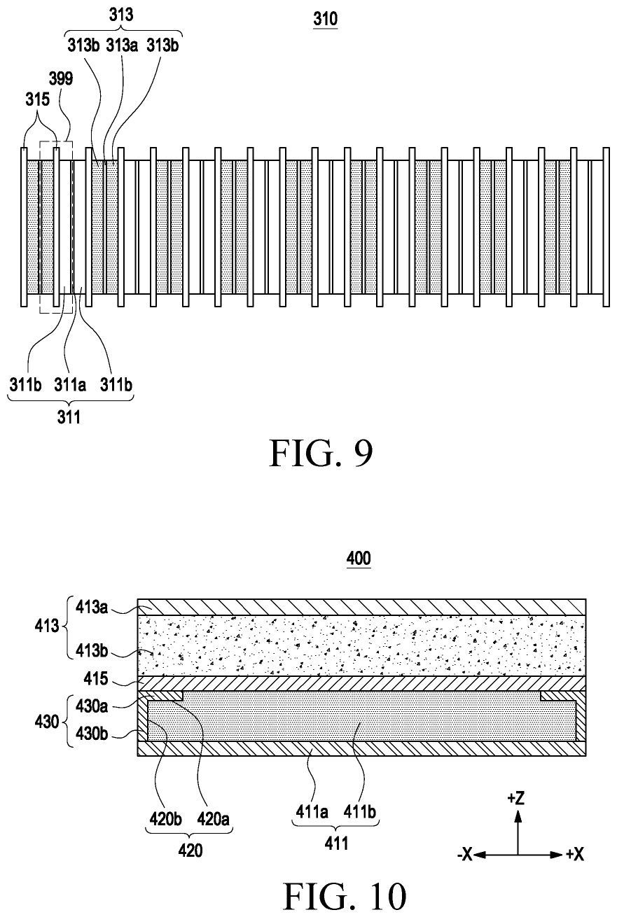

FIG. 9 is a view illustrating an electrode assembly according to various embodiments.

Referring to FIG. 9, an electrode assembly 310 may include a positive electrode 311, a negative electrode 313, and a separator 315. The configuration of the positive electrode 311, the negative electrode 313, and the separator 315 of FIG. 9 may be identical in whole or part to the configuration of the positive electrode 311, the negative electrode 313, and the separator 315 of FIGS. 5 to 8.

According to various embodiments, the positive electrode 311 may include a positive electrode substrate 311a and a positive electrode mixture 311b disposed on the positive electrode substrate 311a. According to an embodiment, the positive electrode substrate 311a may include aluminum (Al). According to an embodiment, the positive electrode mixture 311b may include lithium (Li) oxide including a transition metal (e.g., at least one of cobalt (Co), manganese (Mn), or iron (Fe)). According to an embodiment, the positive electrode mixture 311b may be disposed adjacent to and surround at least a portion of the positive electrode substrate 311a. For example, the positive electrode substrate 311a may be disposed between a pair of positive electrode mixtures 311b.

According to various embodiments, the negative electrode 313 may include a negative electrode substrate 313a and a negative electrode mixture 313b. According to an embodiment, the negative electrode substrate 313a may include nickel (Ni) and/or copper (Cu). According to an embodiment, the negative electrode mixture 313b may include graphite and/or lithium (Li) titanium (Ti) oxide. According to an embodiment, the negative electrode mixture 313b may surround at least a portion of the negative electrode substrate 313a. For example, the negative electrode substrate 313a may be disposed between a pair of negative electrode mixtures 313b.

According to various embodiments, the separator 315 may physically separate the positive electrode 311 and the negative electrode 313. The separator 326 may be a non-conductive porous body with pores configured to transport a designated material (e.g., lithium (Li) ions). According to an embodiment, the separator 315 may be a synthetic resin (e.g., polyethylene or polypropylene). According to an embodiment, the electrode assembly 310 may include a plurality of separators 315. For example, some of the plurality of separators 315 may be disposed between the positive electrode 311 and the negative electrode 313, and others may be disposed on the positive electrode 311 or the negative electrode 313.

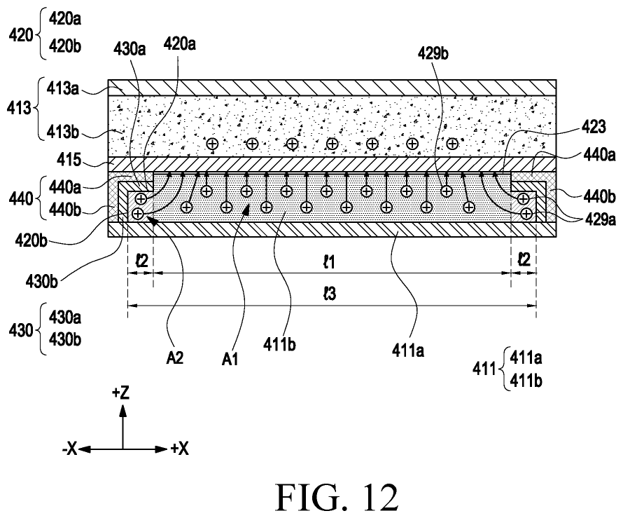

According to various embodiments, the electrode assembly 310 may include an ion barrier structure (e.g., the ion barrier structure 400 of FIG. 10). According to various embodiments, the ion barrier structure (e.g., the ion barrier structure 400 of FIG. 10) may include the positive electrode 311, the negative electrode 313, the separator 315, an ion barrier (e.g., the ion barrier 430 of FIG. 10), and/or an insulation layer (e.g., the insulation layer 440 of FIG. 12) and may be provided by an arrangement relationship or a combination thereof. The ion barrier structure (e.g., the ion barrier structure 400 of FIG. 10) may control the transfer path of cations transferred from the positive electrode 311 to the negative electrode 313 and may contribute to an increase in the capacity of the battery 300.

The ion barrier structure is described below with reference to various enlarged views (e.g., FIGS. 10 to 16) of a partial area 399 of the electrode assembly 310.

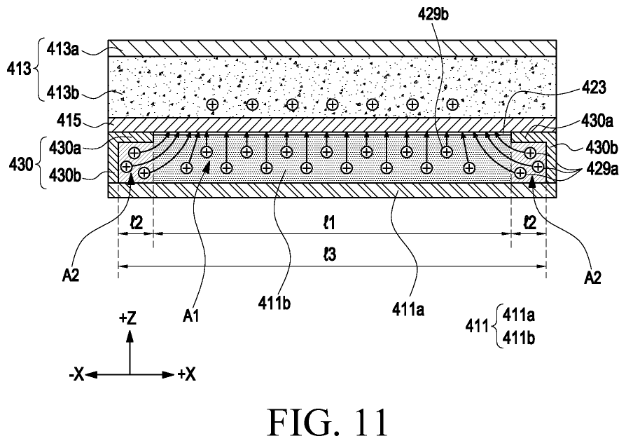

FIG. 10 is a view illustrating an ion barrier structure according to various embodiments. FIG. 11 is a view illustrating an ion movement in an ion barrier structure according to various embodiments. FIG. 12 is a view illustrating an ion barrier structure including an insulation layer according to various embodiments.

Referring to FIGS. 10 and 11, an ion barrier structure 400 may include a separator 415, a positive electrode 411 and a negative electrode 413 disposed to face each other with the separator 415 interposed therebetween, and the positive electrode 411 may include an ion barrier 430. For example, the positive electrode 411 may include a positive electrode substrate 411a and a positive electrode mixture 411b disposed on the positive electrode substrate 411a. The negative electrode 413 may include a negative electrode substrate 413a and a negative electrode mixture 413b disposed on the negative electrode substrate 413a. The separator 415 may be disposed between the positive electrode mixture 411b and the negative electrode mixture 413b.

The description of the positive electrode 311, the positive electrode substrate 311a, the positive electrode mixture 311b, the negative electrode 313, the negative electrode substrate 313a, the negative electrode mixture 313b, and the separator 315 in the above-described embodiments may be applied to the description of the positive electrode 411, the positive electrode substrate 411a, the positive electrode mixture 411b, the negative electrode 413, the negative electrode substrate 411a, the negative electrode mixture 411b, and the separator 415 of FIGS. 10 and 11.

According to various embodiments, the positive electrode mixture 411b may include a barrier receiving area 420. According to an embodiment, the barrier receiving area 420 may be formed by etching a portion of the positive electrode mixture 411b. For example, the barrier receiving area 420 may be formed near an edge of the positive electrode mixture 411b. According to an embodiment, the barrier receiving area 420 may include a first receiving area 420a and a second receiving area 420b. For example, the first receiving area 420a may be an area in which a portion of the edge of the front surface (e.g., the surface facing the separator 415) of the positive electrode mixture 411b has been etched, and the second receiving area 420b may be an area in which a portion of the side edge of the positive electrode mixture 411b has been etched.

According to various embodiments, the ion barrier 430 may be disposed on at least a portion of the positive electrode mixture 411b. According to an embodiment, the ion barrier 430 may be positioned in the barrier receiving area 420. For example, the ion barrier 430 may be deposited by atomic layer deposition, chemical layer deposition, and/or physical vapor deposition.

According to various embodiments, the ion barrier 430 may include a first barrier area 430a and a second barrier area 430b. For example, the first barrier area 430a may be a portion of the ion barrier 430 disposed in the first receiving area 420a, and the second barrier area 430b may be a portion of the ion barrier 430 disposed in the second receiving area 420b. As another example, the first barrier area 430a may be a partial area of the ion barrier 430 disposed on the upper portion (e.g., in the +Z-axis direction) of the positive electrode mixture 411b, and the second barrier area 430b may be a portion of the ion barrier 430 disposed to face the side surface (e.g., −X-axis direction) of the positive electrode mixture 411b.

According to various embodiments, the ion barrier 430 may be formed of a material for preventing the permeation of ions. According to an embodiment, the ion barrier 430 may be a metal nitride For example, the ion barrier 430 may include titanium nitride (TiN), titanium aluminum nitride (TiAlN), chromium nitride (CrN), zirconium nitride (ZrN), or titanium chromium-nitride (TiCrN). According to another embodiment, the ion barrier 430 may be formed of a polymer material.

According to various embodiments (refer to FIG. 11), the ion barrier 430 may induce the cations 429a and 429b to be transferred to the negative electrode 413 through a predetermined area of the positive electrode mixture 411b. According to an embodiment, the ion barrier 430 may induce the cations 429a stored in the side area A2 of the positive electrode mixture 411b to be transferred to the negative electrode 413 through a transfer surface 423 formed in a center area A1 of the positive electrode mixture 411b. For example, the positive ions 429a stored in the side area A2 may be prevented from being transferred to the negative electrode 413 through the area in which the first barrier area 430a and the second barrier area 430b are positioned and be moved to the negative electrode 413 through the center area A1 and the transfer surface 423. For example, the defined area may include the transfer surface 423.

According to various embodiments, the ion barrier structure 400 including the ion barrier 430 may have an additional ion storage area (e.g., the side area A2). For example, in the absence of the ion barrier 430, the positive electrode mixture 411b may be formed shorter than the length of the negative electrode mixture 413b to prevent ion dendrites at the negative electrode 413 (e.g., the positive electrode mixture 411b area having a first length 11). According to an embodiment, the ion barrier 430 prevents the ions 429a stored in the additional storage area A2 from moving through the area where the first barrier area 430a and the second barrier area 430b are positioned so that a storage area A2 having a second length 12 in addition to the center area A1 having the first length 11 may be formed in the positive electrode mixture 411b. According to an embodiment, the ion barrier 430 may be formed on only one side of the positive electrode mixture 411b, or two opposite sides thereof. Thus, the positive electrode mixture 411b may have a width that is as long as a third length 13 which is the sum of the first length 11 corresponding to the center area A2 and the second length 12 corresponding to the storage area A2 formed on the two opposite sides. According to an embodiment, the third length 13 may correspond to the width of the negative electrode mixture (e.g., the negative electrode mixture 413b of FIG. 9). For example, the third length 13 may be substantially equal to or longer than the width of the negative electrode mixture (e.g., the negative electrode mixture 413b of FIG. 9). According to an embodiment, the first length 11 and the second length 12 may have a predetermined ratio. For example, the second length 12 may correspond to about 5% to about 10% of the first length 11.

FIG. 12 is a view illustrating an ion barrier structure including an insulation layer.

Referring to FIG. 12, the ion barrier structure 400 may include an insulation layer 440. According to various embodiments, the insulation layer 440 may increase the electrical resistance of the positive electrode 411 and may suppress the movement of electrons from the positive electrode 411 to the negative electrode 413. For example, the insulation layer 440 may enhance the insulation of the edge area of the positive electrode 411 and prevent the occurrence of a short circuit by an external impact or an internal foreign object. The ion barrier structure 400 of FIG. 12 may be identical in whole or part to the ion barrier structure 400 of FIGS. 10 and 11.

According to various embodiments, the insulation layer 440 may be disposed adjacent to the ion barrier 430. For example, the insulation layer 440 may be disposed adjacent to and to surround at least a portion of the ion barrier 430 or may be disposed between the ion barrier 430 and the positive electrode mixture 411b. According to an embodiment, the insulation layer 440 may include a first insulation portion 440a and a second insulation portion 440b. For example, the first insulation portion 440a may mean a portion of the insulation layer 440 corresponding to the first barrier area 430a. For example, the first insulation portion 440a may mean a portion of the insulation layer 440 disposed on the upper portion (e.g., in the +Z-axis direction) of the first barrier area 430a. According to another embodiment, the first insulation portion 440a may also be a portion of the insulation layer 440 facing the separator 415. The second insulation portion 440b may be a portion of the insulation layer 440 corresponding to the second barrier area 430b. For example, the second insulation portion 440b may be a portion of the insulation layer 440 disposed on a side surface (e.g., −X-axis direction) of the second barrier area 430b. According to another embodiment, the second insulation portion 440b may be a portion of the insulation layer 440 facing the side surface (e.g., −X-axis direction). The insulation layer 440 may perform an additional insulation function of the ion barrier structure 400. FIG. 12 illustrates that the insulation layer 440 is disposed adjacent to and to surround at least a portion of the ion barrier 430, but embodiments are not limited thereto, and, the insulation layer 440 may also be disposed between the ion barrier 430 and the positive electrode mixture 411b as in embodiments to be described below.

According to various embodiments, the barrier receiving area 420 may be formed considering the thickness of the ion barrier 430 and/or the insulation layer 440. According to an embodiment, the thickness of the first receiving area 420a may be formed such that the ion first barrier area 420a and/or the first insulation portion 440a disposed in the first receiving area 420a corresponds to the transfer surface 423. As another example, the thickness of the second receiving area 420b may be formed that the second barrier area 420b and/or the second insulation portion 440b disposed in the second receiving area 420b does not protrude further than the separation film 415. However, embodiments are not limited thereto, and at least a portion of the ion barrier 430 and/or the insulation layer 440 may be disposed to protrude (e.g., protrude in the +Z-axis direction) further than the transfer surface 423. According to an embodiment, the first length 11 and the second length 12 may have a predetermined ratio. For example, the second length 12 may correspond to about 5% to about 10% of the first length 11.

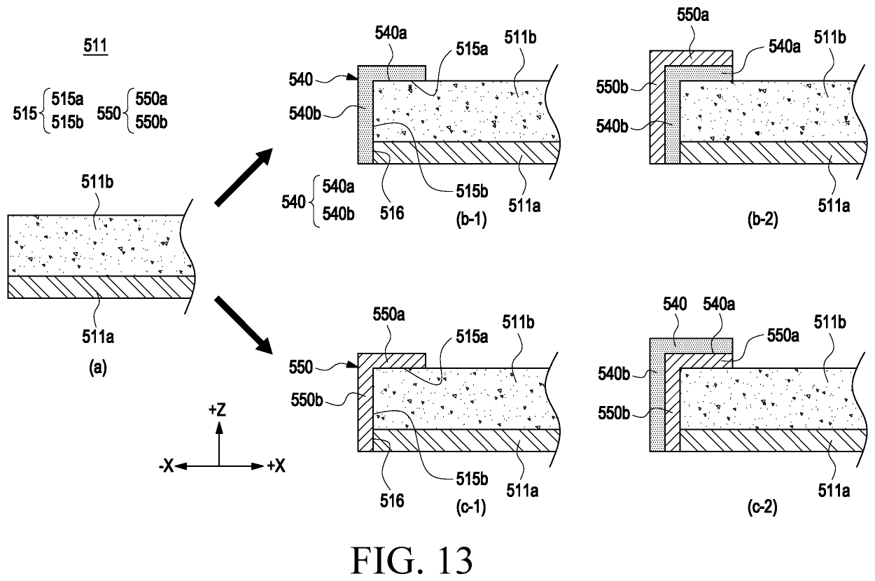

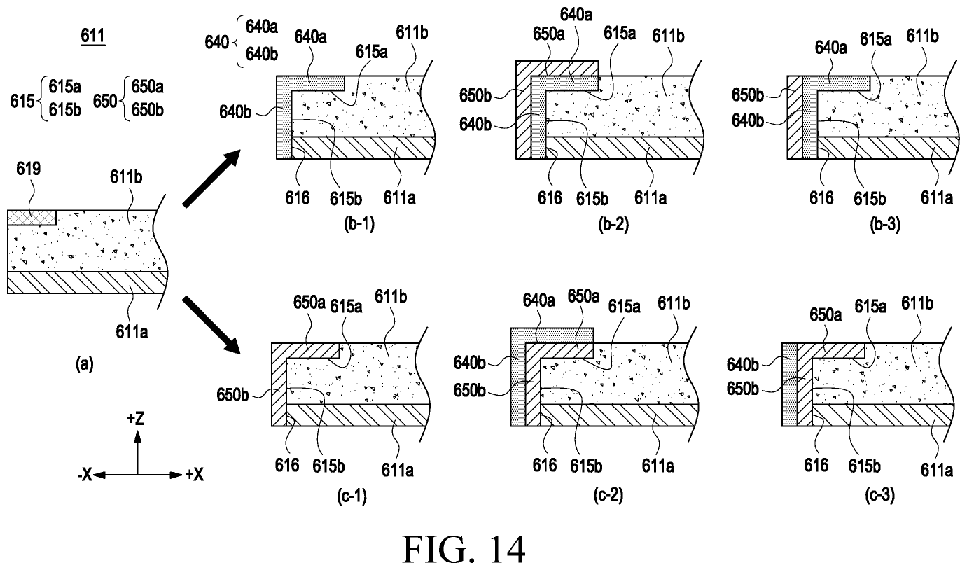

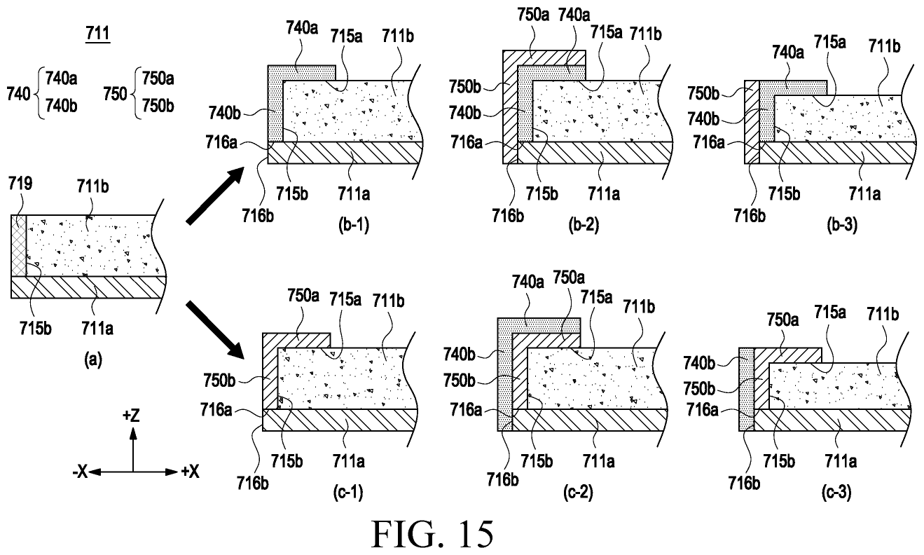

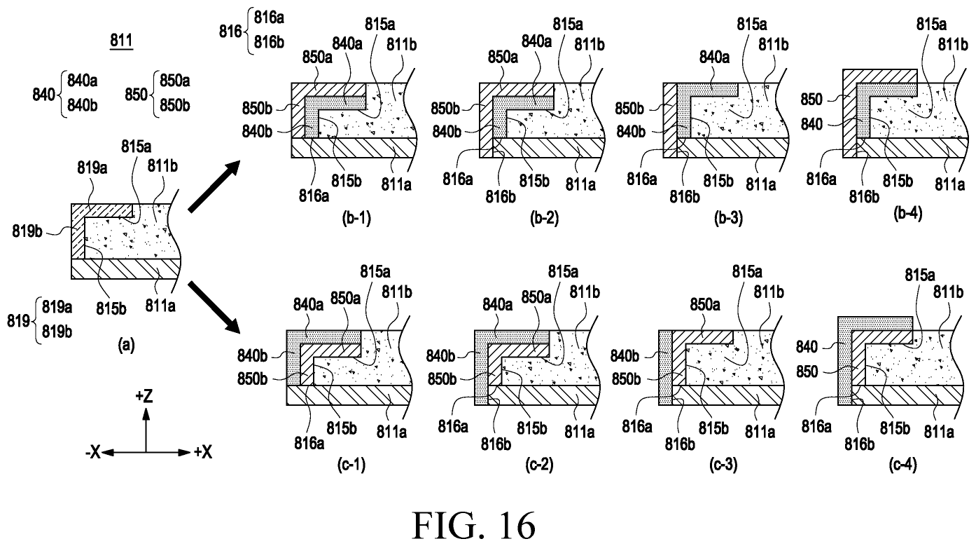

FIGS. 13 to 16 are views illustrating a process for manufacturing an ion battery structure according to a first embodiment. FIG. 13 is a view illustrating a process for manufacturing an ion barrier structure according to a first embodiment. FIG. 14 is a view illustrating a process for manufacturing an ion barrier structure according to a second embodiment. FIG. 15 is a view illustrating a process for manufacturing an ion barrier structure according to a third embodiment. FIG. 16 is a view illustrating a process for manufacturing an ion barrier structure according to a fourth embodiment.

Referring to FIG. 13, the ion barrier 540 and/or the insulation layer 550 may be disposed on the edge area 516 of the positive electrode mixture 511b. For example, the positive electrode mixture 511b may not include a separate barrier receiving area (e.g., the barrier receiving area 430 of FIGS. 10 and 11), and the ion barrier 540 and/or the insulation layer 550 may be disposed adjacent to and to surround the edge area 516 of the positive electrode mixture 511b. The description of the positive electrode 411 according to the above-described embodiments may be applied to the positive electrode 511 of FIG. 13.

According to various embodiments (referring to b-1), the ion barrier 540 may be disposed adjacent to and to surround the edge area 515a of the upper surface (surface in the +Z-axis direction) of the positive electrode mixture 511b and the edge area 515 of the side surface (surface in the −X-axis direction) connected with the upper edge area 515a. For example, the first barrier area 540a of the ion barrier 540 may be disposed to cover the upper edge area 515a, and the second barrier area 540b may be disposed to cover the side edge area 515b. According to an embodiment, the ion barrier 540 may be disposed to cover a portion of the positive electrode substrate 511a. For example, the second barrier area 540b may be disposed to cover the whole or part of the side surface 516 (surface in the −X-axis direction) of the positive electrode substrate 511a.

According to various embodiments (referring to b-2), the insulation layer 550 may be disposed adjacent to and to surround at least a portion of the ion barrier 540. For example, the first insulation portion 550a of the insulation layer 550 may be disposed on an upper portion (e.g., in the +Z-axis direction) of the first barrier area 540a, and the second insulation portion 550b may be disposed on an upper portion (e.g., in the −X-axis direction) of the second barrier area 540b.

According to various embodiments, similar to the description made in connection with (b-1) and (b-2), the insulation layer 550 may be disposed to cover the edge area 516 of the positive electrode mixture 511b and/or the side surface (e.g., the surface in the −X-axis direction) of the positive electrode substrate 511a, and the ion barrier 540 may then be disposed on the upper portion (e.g., in the +Z-axis direction) of the insulation layer 550 ((c-1) and (c-2)).

Referring to FIG. 14, the positive electrode mixture 611b may include a barrier receiving area 615a formed in an edge area of the upper surface (e.g., the surface in the +Z-axis direction). The description of the positive electrodes 311, 411, and 511 according to the above-described embodiments may be applied to the positive electrode 611 of FIG. 14.

According to various embodiments, a partial area of the edge of the upper surface (e.g., the surface in the +Z-axis direction) of the positive electrode mixture 611b may be etched. For example, the etched partial area of the front edge of the positive electrode mixture 611b may be referred to as an etch area 619. For example, the etched area 619 may be etched to form the barrier receiving area 615a.

According to various embodiments, the ion barrier 640 and/or insulation layer 650 may be disposed in the barrier receiving area 615a. According to an embodiment, at least a portion of the ion barrier 640 and/or the insulation layer 650 may be disposed in the barrier receiving area 615a, and another portion may be disposed to cover the whole or part of the side surface (e.g., in the −X-axis direction) of the positive electrode substrate 611a and the side area 615b of the positive electrode mixture 611b.

According to an embodiment (referring to b-1), the first barrier area 640a of the ion barrier 640 may be disposed in the barrier receiving area 615a, and the second barrier area 640b may be disposed to cover the side edge area 615b. According to an embodiment, the second barrier area 640b may be disposed to cover the whole or part of the side surface 616 of the positive electrode substrate 611a. For example, the thickness of the first barrier area 640a may correspond to the depth of the barrier receiving area 615a.

According to an embodiment (referring to b-2), after the ion barrier 640 is disposed, the insulation layer 650 may be disposed to cover at least a portion of the ion barrier 640. For example, the first insulation portion 650a of the insulation layer 650 may be disposed on an upper portion (e.g., in the +Z-axis direction) of the first barrier area 640a, and the second insulation portion 650b may be disposed on the second barrier area 640b.

According to an embodiment (referring to b-3), after the ion barrier 640 is disposed, the insulation layer 650 may be disposed only in a partial area of the ion barrier 640. For example, the insulation layer 650b may be disposed only on the second barrier area 640b or, may be disposed only on the first barrier area 640a.

According to various embodiments, the insulation layer 650 may be disposed first and the ion barrier 640 may be disposed on the insulation layer 650 ((c-1), (c-2) and (c-3)). In this case, the description made in connection with (b-1), (b-2) and (b-3) may apply. For example, the insulation layer 650 may be disposed to cover the barrier receiving area 615a formed in the edge area of the upper surface (e.g., the surface in the +Z-axis direction) of the positive electrode mixture 611b, the side edge area 615b, and/or the side surface (e.g., the surface in the −X-axis direction) of the positive electrode substrate 511a, and the ion barrier 640 may be disposed on the insulation layer 650 ((c-1) and (c-2)).

Referring to FIG. 15, the positive electrode mixture 711b may include a barrier receiving area 715a formed in an edge area of the side surface (e.g., the surface in the −X-axis direction). According to various embodiments, the side etched area 719 of the positive electrode mixture 711b may be etched, forming a barrier receiving area 715b. The description of the positive electrodes 311, 411, 511, and 611 according to the above-described embodiments may be applied to the positive electrode 711 of FIG. 15.

According to various embodiments, at least a portion of the ion barrier 740 and/or insulation layer 750 may be disposed in the barrier receiving area 715a. According to an embodiment, at least a portion of the ion barrier 740 and/or the insulation layer 750 may be disposed to cover the whole or part of the upper surface (e.g., the surface in the +Z-axis direction) of the positive electrode substrate 711a and the barrier receiving area 715b, and another portion may be disposed to cover the upper edge area 715a.

According to an embodiment (referring to b-1), first, the first barrier area 740a of the ion barrier 740 may be disposed to cover the upper edge area 715a, and the second barrier area 740b may be disposed to cover the barrier receiving area 715b. According to an embodiment, the second barrier area 740b may be disposed to cover the edge area 716a of the upper surface (e.g., the surface in the +Z-axis direction) of the positive electrode substrate 711a.

According to an embodiment (referring to b-2), after the ion barrier 740 is disposed, the insulation layer 750 may be disposed adjacent to and to surround at least a portion of the ion barrier 740. For example, the first insulation portion 750a of the insulation layer 750 may be disposed on an upper portion (e.g., in the +Z-axis direction) of the first barrier area 740a, and the second insulation portion 750b may be disposed on an upper portion (e.g., in the −X-axis direction) of the second barrier area 740b. Further, the second insulation portion 750b may be disposed to cover the edge area of the side surface (e.g., in the −X-axis direction) of the positive electrode substrate 711a.

According to an embodiment (referring to b-3), after the ion barrier 740 is disposed, the insulation layer 750 may be disposed only in a partial area of the ion barrier 740. For example, the insulation layer 750b may be disposed only on the second barrier area 740b. In this case, the insulation layer 750b may be disposed to cover the side edge area 716a of the positive electrode substrate 711a. As another example, the insulation layer 750b may be disposed only on the first barrier area 740a (e.g., in the +Z-axis direction).

According to various embodiments, at least a portion of the insulation layer 750 may be disposed between the ion barrier 740 and the positive electrode mixture 711b ((c-1), (c-2) and (c-3)). In this case, the description made in connection with (b-1), (b-2) and (b-3) may apply. For example, the insulation layer 750 may first be disposed to cover the upper edge area 715a of the positive electrode mixture 711b, the barrier receiving area 715b connected with the upper edge area 715a, and/or the side edge area 716b of the positive electrode substrate 711a, and the ion barrier 740 may be disposed on the insulation layer 750 ((c-1), (c-2), and (c-3)).

Referring to FIG. 16, the positive electrode mixture 811b may include a first barrier receiving area 815a formed in the edge area of the upper surface (e.g., in the +Z-axis direction) and a second barrier receiving area 815b formed in the edge area of the side surface (e.g., in the −X-axis direction). According to various embodiments, the first etch area 819a, which is the edge area of the upper surface (e.g., the surface in the +Z-axis direction) of the positive electrode mixture 811b, and the second etch area 819b, which is the edge area of the side surface (e.g., the surface in the −X-axis direction) may be etched, forming the first barrier receiving area 815a and the second barrier receiving area 815b. The description of the positive electrodes 311, 411, 511, 611, and 711 according to the above-described embodiments may be applied to the positive electrode 811 of FIG. 16.

According to various embodiments, the ion barrier 840 and/or insulation layer 850 may be disposed in the first barrier receiving area 815a and the second barrier receiving area 815b. According to an embodiment, at least a portion of the ion barrier 840 and/or insulation layer 850 may be disposed to cover the first barrier receiving area 815a, and another portion may be disposed to cover the whole or part of the upper surface 816a and/or the side surface 816b of the positive electrode substrate 811a and the second barrier receiving area 815b.

According to various embodiments (referring to b-1 or b-2), first, the first barrier area 840a of the ion barrier 840 may be disposed to cover the first barrier receiving area 815a, and the second barrier area 840b may be disposed to cover the second barrier receiving area 815b. According to an embodiment, after the ion barrier 840 is stacked, the insulation layer 850 may be stacked on the ion barrier 840. For example, the first insulation portion 850a may be disposed on the first barrier area 840a, and the second insulation portion 850b may be disposed on the second barrier area 840b. According to an embodiment, the sum of the thicknesses of the first barrier area 840a and the first insulation portion 850a may correspond to the depth of the first barrier receiving area 815a. According to an embodiment, the stacked thickness of the second barrier area 840b and the second insulation portion 850b may correspond to the depth of the second barrier receiving area 815b, and the second barrier area 840b and the second insulation portion 850b may be disposed to cover the whole or part of the edge 816a of the upper surface (e.g., the surface in the +Z-axis direction) of the positive electrode substrate 811a. According to another embodiment, the thickness of the second barrier area 840b and the depth of the second barrier receiving area 815b may correspond to each other, so that at least a portion of the second barrier area 840b may be disposed to cover the upper edge 816a of the positive electrode substrate 811a, and the second insulation portion 850b may be disposed to cover the edge 816b of the side surface (e.g., the surface in the −X-axis direction) of the positive electrode substrate 811a.

According to various embodiments (referring to b-3 or b-4), the depth of the barrier receiving area 815 and the stacked thickness of the ion barrier 840 may correspond to each other. For example, the ion barrier 840 may be disposed to cover the first and second barrier receiving areas 815a and 815b and the upper edge area 816a of the positive electrode substrate 811a. According to an embodiment, after the ion barrier 840 is stacked, the insulation layer 850 may be disposed to protrude from a front portion and/or side surface of the positive electrode mixture 811b. According to an embodiment, the insulation layer 850 may be disposed only in a partial area of the ion barrier 840. For example, the insulation layer 850b may be disposed only on the second barrier area 840b. In this case, the insulation layer 850b may be disposed to cover the side edge 816b of the positive electrode substrate 811a. As another example, the insulation layer 850 may be disposed to cover the whole of the ion barrier 840 and the side edge 816b of the positive electrode substrate 811a.

According to various embodiments (referring to b-1, b-2, b-3, and b-4), the thickness to which the ion barrier 840 and/or insulation layer 850 is deposited may be determined by considering the depth of the barrier receiving area 815. According to an embodiment, the sum of the thicknesses at which the ion barrier 840 and the insulation layer 850 are stacked may correspond to the depth of the barrier receiving area 815. For example, the sum of the thicknesses of the first barrier area 840a and the first insulation portion 850a may correspond to the thickness of the first etch area 819a, and the sum of the second barrier area 840b and the second insulation portion 850b may correspond to the thickness of the second etch area 819b. For example, the thickness at which the ion barrier 840 and/or the insulation layer 850 is deposited may also be expressed as determined considering the thickness of the area where the positive electrode mixture 811b is etched (e.g., the first etch area 819a and the second etch area 819b). According to another example, the stacked thickness of one of the ion barrier 840 or the insulation layer 850 may correspond to the depth of the barrier receiving area 815. For example, the thickness of the ion barrier 840 may correspond to the thickness of the etch area 819 and, as the insulation layer 850 is stacked on the ion barrier 840, the insulation layer 850 may be disposed to protrude from the upper portion (e.g., in the +Z-axis direction) and/or the side portion (e.g., in the −X-axis direction) of the ion barrier 840.

According to various embodiments, the insulation layer 850 may be disposed first and the ion barrier 840 may be disposed on the insulation layer 850. As another example, the insulation layer 850 may be disposed between the ion barrier 840 and the positive electrode mixture 811 ((c-1), (c-2), (c-3), and (c-4)). In this case, the description made in connection with (b-1), (b-2), (b-3), and (b-4) may apply.

In the above embodiments, it has been mainly described that some areas of the positive electrode mixtures 411b, 511b, 611b, 711b, and 811b are etched, but embodiments are not limited thereto. As an example, embodiments related to the etching of the positive electrode mixture 411b, 511b, 611b, 711b, or 811b according to various embodiments may also be achieved by adjusting the coating thickness of the positive electrode mixture 411b, 511b, 611b, 711b, or 811b. For example, the barrier receiving area (e.g., the barrier receiving area 420 of FIG. 10) of the positive electrode mixture (e.g., the positive electrode mixture 411a of FIG. 10) may be provided by a coating of a positive electrode active material layer, corresponding to the side area (e.g., the side area A2 of FIG. 11) of the positive electrode mixture (e.g., the positive electrode mixture 411a of FIG. 10), thinner than the center area (e.g., the center area A1 of FIG. 11). Similarly, it will be understood that all the etching-related embodiments of the disclosure may be achieved by adjusting the coating thickness of the positive electrode mixture.

According to various embodiments, there may be provided a battery comprising a negative electrode (e.g., the negative electrode 313 of FIG. 9) including a negative electrode substrate layer (e.g., the negative electrode substrate layer 313a of FIG. 9) and a negative electrode active material-coated negative electrode mixture layer (e.g., the negative electrode mixture 313b of FIG. 9) on the negative electrode substrate layer; a positive electrode (e.g., the positive electrode 311 of FIG. 9) disposed to face the negative electrode including a positive electrode substrate layer (e.g., the positive electrode substrate 311a of FIG. 9), a positive electrode active material-coated positive electrode mixture layer (e.g., the positive electrode mixture 311b of FIG. 9) on the positive electrode substrate layer, and a barrier layer (e.g., the ion barrier 430 of FIG. 10) configured to suppress transfer of ions from the positive electrode mixture layer, and a separator (e.g., the separator 415 of FIG. 9) disposed between the negative electrode and the positive electrode, wherein the positive electrode mixture layer includes a first area (e.g., the center area A1 of FIG. 11) positioned in a center area of the positive electrode mixture layer and a second area (e.g., the side edge area A2 of FIG. 11) positioned in an edge of the positive electrode active material layer, and wherein the barrier layer is disposed to cover at least a portion of the second area to limit direct transfer of the ions from the first area to the negative electrode.

According to an embodiment, there may be provided the battery, wherein the second area includes at least a portion from an upper edge area of the positive electrode mixture layer to a side surface extending from the edge area.

According to an embodiment, there may be provided the battery, wherein the second area is formed as at least a portion of an upper edge of the positive electrode mixture layer is etched.

According to an embodiment, there may be provided the battery, wherein the second area is formed as at least a portion of a side surface of the positive electrode mixture layer is etched.

According to an embodiment, there may be provided the battery, wherein the second area is formed as a portion of an upper surface and of the positive electrode mixture layer and at least a portion of a side surface of the positive electrode mixture layer are etched.

According to an embodiment, there may be provided the battery, wherein the barrier layer is disposed to cover at least a portion of the positive electrode substrate layer.

According to an embodiment, there may be provided the battery, further comprising an insulation layer (e.g., the insulation layer 440 of FIG. 12) configured to suppress movement of electrons; and wherein the insulation layer corresponds to at least a portion of the barrier layer and is disposed inside or outside the barrier layer.

According to an embodiment, there may be provided the battery, wherein the insulation layer is disposed to further cover at least a portion of the positive electrode substrate layer.

According to an embodiment, there may be provided the battery, wherein the barrier layer is formed of at least one material among a metal nitride or a polymer material.

According to an embodiment, there may be provided the battery, wherein the barrier layer is deposited using atomic layer deposition.

According to an embodiment, there may be provided the battery, wherein a width of the negative electrode mixture layer corresponds to a width of the positive electrode mixture layer.

According to an embodiment, there may be provided the battery, wherein the battery includes a jelly-roll type or a stack type.

According to an embodiment, there may be provided the battery, wherein a thickness of the second area is formed to be smaller than a thickness of the first area.

According to an embodiment, there may be provided the battery, wherein the second area is formed as at least a portion of an upper edge of the positive electrode mixture layer is etched or is coated to be thinner than a center area of the positive electrode mixture layer.

According to an embodiment, there may be provided the battery, wherein a length of the second area is formed to be 5% to 10% of a length of the first area.

According to various embodiments, there may be provided a battery comprising a negative electrode (e.g., the negative electrode 313 of FIG. 9) including a negative electrode substrate layer (e.g., the negative electrode substrate 313a of FIG. 9) and a negative electrode active material-coated negative electrode mixture layer (e.g., the negative electrode mixture 313b of FIG. 9) on the negative electrode substrate layer, a positive electrode (e.g., the positive electrode 311 of FIG. 9) disposed to face the negative electrode including a positive electrode substrate layer (e.g., the positive electrode substrate 311a of FIG. 9), a positive electrode active material-coated positive electrode mixture layer (e.g., the positive electrode mixture 311b of FIG. 9) on the positive electrode substrate layer; and a barrier layer (e.g., the ion barrier 430 of FIG. 11) for suppressing transfer of ions from the positive electrode mixture layer, and a separator (e.g., the separator 415 of FIG. 9) disposed between the negative electrode and the positive electrode, wherein the positive electrode mixture layer includes a main area (e.g., the center area A1 of FIG. 11) storing cations and including a transfer area for transferring the cations to the negative electrode; and an additional area (e.g., the additional area A2 of FIG. 11) extending from the main area to additionally store the cations, and wherein the barrier layer is disposed to cover the additional area to suppress direct transfer, to the negative electrode, of the cations stored in the additional area.

According to an embodiment, there may be provided the battery, wherein there is included a barrier receiving area (e.g., the barrier receiving area 420 of FIG. 10) formed as at least a portion of the additional area is etched, and the barrier layer is disposed in the barrier receiving area.

According to an embodiment, there may be provided the battery, wherein the barrier layer is disposed to cover at least a portion of the positive electrode substrate layer.

According to an embodiment, there may be provided the battery, further comprising an insulation layer (e.g., the insulation layer 440 of FIG. 12) configured to suppress movement of electrons, and wherein the insulation layer is disposed to correspond to at least a portion of an inside or outside of the barrier layer.

According to an embodiment, there may be provided the battery, wherein the insulation layer is disposed to cover at least a portion of the positive electrode substrate layer.

According to an embodiment, there may be provided the battery, wherein the barrier layer includes a metal nitride or a polymer material.

According to an embodiment, there may be provided the battery, wherein the barrier layer is deposited using atomic layer deposition.

According to an embodiment, there may be provided the battery, wherein a width of the negative electrode mixture layer corresponds to a width of the positive electrode mixture layer.

According to various embodiments, there may be provided an electronic device comprising a processor, and a battery (e.g., the battery 300 of FIG. 6) for supplying power to the processor; wherein the battery includes a negative electrode (e.g., the negative electrode 413 of FIG. 10) including a negative electrode substrate layer (e.g., the negative electrode substrate layer 413a of FIG. 10) and a negative electrode active material-coated negative electrode mixture layer (e.g., the negative electrode mixture 413b of FIG. 10) on the negative electrode substrate layer, a positive electrode (e.g., the positive electrode 411 of FIG. 10) disposed to face the negative electrode including a positive electrode substrate layer (e.g., the positive electrode substrate 411a of FIG. 10), a positive electrode active material-coated positive electrode mixture layer (e.g., the positive electrode mixture 411b of FIG. 10) on the positive electrode substrate layer; and a barrier layer (e.g., the ion barrier 430 of FIG. 10) for suppressing transfer of ions from the positive electrode mixture layer; and a separator (e.g., the separator 415 of FIG. 10) disposed between the negative electrode and the positive electrode, wherein the positive electrode mixture layer includes a first area (e.g., the center area A1 of FIG. 11) positioned in a center area of the positive electrode mixture layer and a second area (e.g., the side edge area A2 of FIG. 11) positioned in an edge of the positive electrode active material layer, and wherein the barrier layer is disposed to cover at least a portion of the second area to limit direct transfer of the ions from the first area to the negative electrode.

While the disclosure has been shown and described with reference to embodiments thereof, it will be apparent to those of ordinary skill in the art that various changes in form and detail may be made thereto without departing from the spirit and scope of the disclosure as defined by the following claims and their equivalents.

What is claimed is:

1. A battery comprising:
a negative electrode comprising a negative electrode substrate layer and a negative electrode active material-coated negative electrode mixture layer on the negative electrode substrate layer;
a positive electrode facing the negative electrode, the positive electrode comprising:
a positive electrode substrate layer;
a positive electrode active material-coated positive electrode mixture layer provided on the positive electrode substrate layer; and
a barrier layer configured to suppress transfer of ions from the positive electrode active material-coated positive electrode mixture layer; and
a separator provided between the negative electrode and the positive electrode,
wherein the positive electrode active material-coated positive electrode mixture layer comprises a first area at a center area of the positive electrode active material-coated positive electrode mixture layer and a second area at an edge of the positive electrode active material-coated positive electrode mixture layer, and
wherein the barrier layer covers at least a portion of the second area and is further configured to limit direct transfer of the ions from the first area to the negative electrode.

2. The battery of claim 1, wherein the second area comprises at least a portion from an upper edge area of the positive electrode active material-coated positive electrode mixture layer to a side surface of the positive electrode active material-coated positive electrode mixture layer extending from the upper edge area.

3. The battery of claim 1, wherein a thickness of the second area is smaller than a thickness of the first area.

4. The battery of claim 3, wherein the second area is formed by etching at least a portion of an upper edge of the positive electrode active material-coated positive electrode mixture layer or is thinner than the center area of the positive electrode active material-coated positive electrode mixture layer.

5. The battery of claim 1, wherein a length of the second area is 5% to 10% of a length of the first area.

6. The battery of claim 1, wherein the barrier layer is provided on at least a portion of the positive electrode substrate layer.

7. The battery of claim 1, further comprising an insulation layer configured to suppress movement of electrons,
wherein the insulation layer is provided inside or outside at least a portion of the barrier layer.

8. The battery of claim 7, wherein the insulation layer covers at least a portion of the positive electrode substrate layer.

9. The battery of claim 1, wherein the barrier layer comprises at least one material among a metal nitride or a polymer material.

10. The battery of claim 1, wherein the barrier layer is deposited by any one of chemical layer deposition, physical vapor deposition, or atomic layer deposition.

11. The battery of claim 1, wherein a width of the negative electrode active material-coated negative electrode mixture layer corresponds to a width of the positive electrode active material-coated positive electrode mixture layer.

12. The battery of claim 1, wherein the battery is a jelly-roll type battery or a stack type battery.

13. A battery comprising:
a negative electrode comprising a negative electrode substrate layer and a negative electrode active material-coated negative electrode mixture layer on the negative electrode substrate layer;
a positive electrode facing the negative electrode, the positive electrode comprising:
a positive electrode substrate layer;
a positive electrode active material-coated positive electrode mixture layer provided on the positive electrode substrate layer; and
a barrier layer configured to suppress transfer of ions from the positive electrode active material-coated positive electrode mixture layer; and
a separator provided between the negative electrode and the positive electrode,
wherein the positive electrode active material-coated positive electrode mixture layer comprises:
a main area configured to store cations and comprising a transfer area configured to transfer the cations to the negative electrode; and
an additional area extending from the main area and configured to store the cations, and
wherein the barrier layer covers the additional area and is configured to suppress the cations stored in the additional area from being directly transferred to the negative electrode.

14. The battery of claim 13, wherein the additional area comprises a barrier receiving area having a thickness that is smaller than a thickness of the main area, and
wherein the barrier layer is provided in the barrier receiving area.

15. The battery of claim 13, wherein the barrier layer covers at least a portion of the positive electrode substrate layer.

16. The battery of claim 13, further comprising an insulation layer configured to suppress movement of electrons,
wherein the insulation layer is provided inside or outside at least a portion of the barrier layer.

17. The battery of claim 16, wherein the insulation layer is provided on at least a portion of the positive electrode substrate layer.

18. The battery of claim 13, wherein the barrier layer comprises a metal nitride or a polymer material.

19. The battery of claim 13, wherein the barrier layer is deposited by any one of chemical layer deposition, physical vapor deposition, or atomic layer deposition.

20. An electronic device comprising:
a processor; and
a battery configured to supply power to the processor;
wherein the battery comprises:
a negative electrode comprising a negative electrode substrate layer and a negative electrode active material-coated negative electrode mixture layer on the negative electrode substrate layer;
a positive electrode facing the negative electrode, the positive electrode comprising:
a positive electrode substrate layer;
a positive electrode active material-coated positive electrode mixture layer provided on the positive electrode substrate layer; and
a barrier layer configured to suppress transfer of ions from the positive electrode active material-coated positive electrode mixture layer; and
a separator provided between the negative electrode and the positive electrode,
wherein the positive electrode active material-coated positive electrode mixture layer comprises a first area at a center area of the positive electrode active material-coated positive electrode mixture layer and a second area at an edge of the positive electrode active material-coated positive electrode mixture layer, and
wherein the barrier layer covers at least a portion of the second area and is further configured to limit direct transfer of the ions from the first area to the negative electrode.
